(19) United States
(12) Patent Application Publication
(10) Pub. No.: US 2005/0209955 A1
(43) Pub. Date: Sep. 22, 2005

(54) Apparatus and method for document processing

(76) Inventors: Timothy J. Underwood, Chandler, AZ (US); Benjamin L. Farrow, Chandler, AZ (US); Joseph Warren LaBonty, Phoenix, AZ (US)

Correspondence Address: Wright Law Group, PLLC;Suite 2, 7201 West Oakland, Chandler, AZ, 85226, US

(21) Appl. No.: 10/802,636

(22) Filed: Mar. 16, 2004

(51) Int. Cl. G06F 17/60

(52) U.S. Cl. 705/38; 705/39

(57) ABSTRACT

The apparatus and methods of the present invention implement a universal document package which combines the loan data, rules, forms and form data into a single complete universal document package along with the tools to support various electronic and manual mortgage processing activities. In the most preferred embodiments of the present invention, the universal document package is implemented as an extensible markup language (XML) document. Additionally, the methods for computer-based procurement, implementation, and use of the universal document package are disclosed.

### 1. FIELD OF THE INVENTION

The present invention relates generally to the real estate finance industry and more specifically relates to the use of computer systems in the population, processing and sharing/distribution of electronic mortgage-related documents.

### 2. BACKGROUND OF THE INVENTION

The real estate finance business is both complex and involved. The number of parties and the amount of data that must be assembled, formatted, and processed for a given mortgage transaction is formidable. Typically, for any given real estate transaction, there is at least a buyer and a seller, one or two brokers and/or agents, at least one financial institution, at least one appraiser, at least one title agency, several government agencies, at least one insurance company, and at least one lawyer. This list is neither complete nor exhaustive and, in certain situations, may include many additional individuals and/or entities. For example, in order to complete a typical mortgage loan transaction, there is often a lender, borrower, settlement agent, title company, escrow company, flood company, and investor.

Not only can the sheer number of participants in the mortgage process be daunting, the types and quantity of data utilized in completing a typical mortgage transaction can be overwhelming. Each of the previously mentioned individuals and entities has very specific, and often divergent, data requirements and needs. Some of the information that is most critical for one individual or entity is not important at all for another entity. Accordingly, the process of collecting, collating, and determining what information will fulfill the needs of the various individuals and entities and then disseminating the appropriate information to the appropriate entity or person is yet another significant task, particularly when you consider that each party or entity typically has their own requirements for data presentation (e.g., paper forms and documents, electronic presentation on computer screens, etc.). Given these disparate needs, the same data may need to be “re-keyed” or reentered by multiple entities during the course of a given transaction. Finally, the different number of forms that must be processed in a given real estate transaction can be well in excess of 50 or more and a complete package for a fairly routine real estate transaction can encompass hundreds of pages. Obviously, more complex transactions can require even more information and, correspondingly, more documents.

Given this somewhat involved background and complex environment, there is a strong desire among the participants in the real estate finance (i.e. mortgage) industry to streamline and simplify the process of gathering the requisite information, populating the necessary documents and sharing the data and documents with the other entities involved in the transaction. Accordingly, over the years, a number of steps have been taken towards this end. In the earliest stage of this simplification process, the parties involved adopted standardized paper forms.

In more recent years, the simplification effort has included the adoption of computer technology in an attempt to automate and streamline the real estate financing process. There are a number of organizations and agencies that have attempted to implement electronic versions of mortgage-related documents and to utilize e-mail, computer-based forms, and electronic data interchange for process simplification. A common point of failure for the majority of these previous simplification efforts is the fact that since the various processes were not “holistic” in nature, only a single piece of data or a single document was addressed and the overall concept of the complete real estate finance transaction was not manifest. This is largely a product of the independent nature of the various entities involved and their widely divergent needs for disparate data elements.

In some cases, these simplification efforts have been the result of collaboration between the various parties with a vested interest in the mortgage process. For example, the Mortgage Industry Standards Maintenance Organization (MISMO) was established by the Mortgage Bankers Association of America (MBA) to coordinate the development and maintenance of Internet-based Extensible Markup Language (XML) real estate finance specifications for data exchange transactions. The result of this effort is a series of specifications for transactions that relate to the electronic exchange of real estate financing and mortgage-related data. However, the approach taken by MISMO for exchanging real estate financing documents is also very “document centric” in that each document is a self-contained entity that is, in a sense, isolated from other, possibly related documents. In fact, current practices have led to an environment where each document is typically completely separate and independent from the other documents in the transaction. Even though the same data may appear on multiple forms, the data is typically entered into each form without regard for the use of the same data on another related form. Accordingly, as the external data related to a given document changes, each document that incorporates that revised data must also be updated to reflect the changes in the information.

Another problem associated with the change in data is the “ripple” effect that occurs due to the altered data in a given form. Certain data changes (i.e. down payments that affect loan-to-value ratios) may precipitate the need for additional forms. Since all necessary forms must be present in order to finalize a given real estate transaction, the isolated nature of the forms may make it very difficult to determine that additional forms are required until very late in the real estate financing process, thereby introducing unwanted and unprofitable delays. As shown by this discussion, the present approach can lead to both inefficiencies and inaccuracies in the overall mortgage process flow, either of which can be very undesirable.

Additionally, even with the adoption of standards and guidelines for exchanging e-mortgage documents and other types of electronic or computer-based real estate finance related transactions, not all participants in the process have adopted a common or universal set of standards. In fact, the standards are constantly evolving and being adapted as technology and various industry requirements change. Accordingly, many of the existing standards that have been adopted are quickly out of date or no longer compatible with other emerging standards. This leads to the undesirable necessity of attempting to ascertain which versions of which transactions and which versions of the data are being used by the various participants in the real estate financing process. In addition, many of the processes and procedures used today are not true “standards” because they have been developed independently and have not been adopted throughout the entire industry. This has further exacerbated the problems already identified by creating additional requirements for translating and deciphering the various results that are produced from the disparate methodologies and technologies.

While the various presently known implementations of mortgage processing methodologies are not without merit, most existing methods of implementing electronic real estate financing documents have one or more significant drawbacks, such as data dependence, data redundancy, data isolation, or the like. In these situations and with the current technology, additional opportunities for the streamlined processing of real estate financing transactions are similarly limited and lack significant potential for growth and industry adoption. Additionally, given the current limitations inherent in the existing technology, lenders are unable to create loan programs to address the ever-changing needs of borrowers in a timely fashion. Accordingly, without developing improved methods of simplifying and streamlining the implementation and exchange of electronic mortgage-related documents, the entire real estate financing process will continue to be sub-optimal.

### SUMMARY OF THE INVENTION

The apparatus and methods of the present invention implement a universal document package which combines the loan data, rules, forms and form data into a single complete universal document package along with the tools to support various electronic and manual mortgage processing activities. In the most preferred embodiments of the present invention, the universal document package is implemented as an extensible markup language (XML) document. Additionally, the methods for computer-based procurement, implementation, and use of the universal document package are disclosed.

### BRIEF DESCRIPTION OF THE DRAWINGS

The preferred embodiments of the present invention will hereinafter be described in conjunction with the appended wherein like designations denote like elements and:

FIG. 1 is a block diagram of the process for implementing a universal document package in accordance with a preferred embodiment of the present invention;

FIG. 2 is a block diagram of a universal document package in accordance with a preferred embodiment of the present invention;

FIG. 3 is a schematic diagram of the process of extracting information from a universal document package in accordance with a preferred embodiment of the present invention;

FIG. 4 is a schematic diagram of the process of inserting a document into a universal document package in accordance with a preferred embodiment of the present invention;

FIG. 5 is a schematic diagram of the process of updating a universal document package in accordance with a preferred embodiment of the present invention;

FIG. 6 is a schematic diagram of the process of requesting loan-specific information from a universal document package, receiving the loan-specific information and then inserting the received information into a universal document package in accordance with a preferred embodiment of the present invention;

FIG. 7 is a block diagram of a computer-based system for procuring and deploying universal document packages in accordance with a preferred embodiment of the present invention;

FIG. 8 is a block diagram of a computer used for procuring and deploying universal document packages in accordance with a preferred embodiment of the present invention;

FIG. 9 is a schematic representation of a document implemented from a universal document package in accordance with a preferred embodiment of the present invention; and

FIG. 10 is a schematic diagram illustrating the implementation of a universal document package during a typical real estate financing transaction in accordance with a preferred embodiment of the present invention.

### DETAILED DESCRIPTION

The apparatus and methods of the present invention implement a universal document package which combines the loan data, rules, forms and form data into a single complete universal document package along with the tools to support various electronic and manual mortgage processing activities. In the most preferred embodiments of the present invention, the universal document package is implemented as an extensible markup language (XML) document. Additionally, the methods for computer-based procurement, implementation, and use of the universal document package are disclosed.

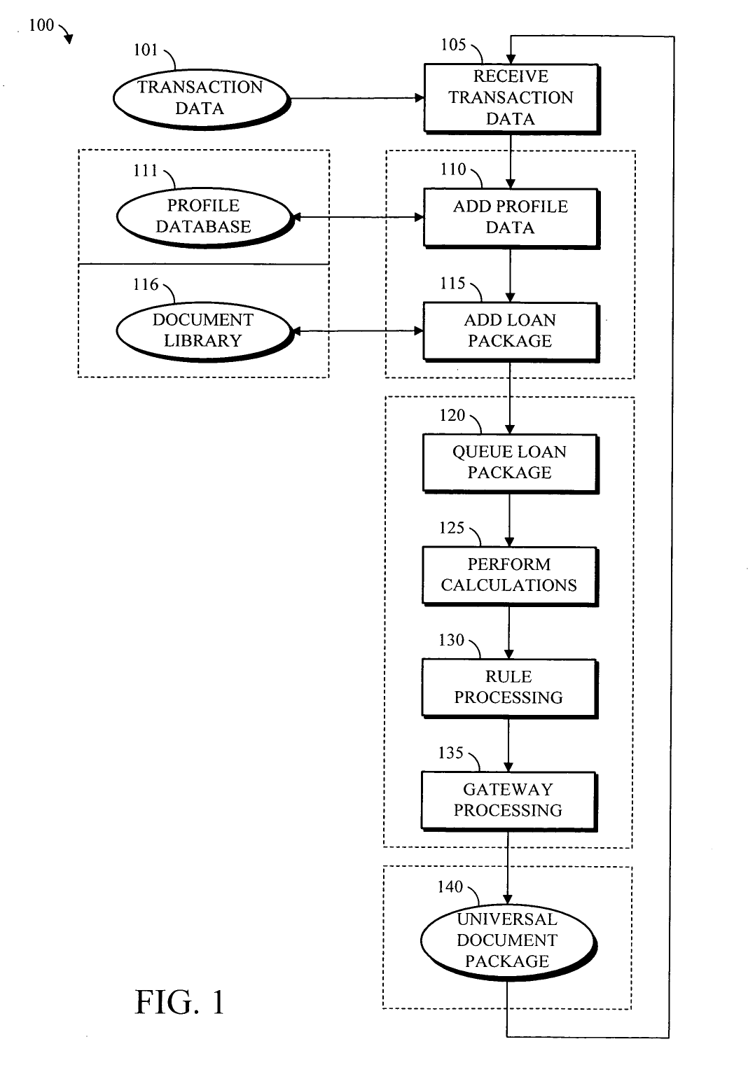

Referring now to FIG. 1, a block diagram 100 depicting the implementation process for a universal document package in accordance with a preferred embodiment of the present invention is shown. A universal document package may be viewed as a data structure or electronic file used for processing real estate financing transactions. As shown in FIG. 1, transaction data 101 is provided for processing a given real estate financing transaction (step 105). Transaction data 101 is transaction-specific data for a given transaction and may include information such as lender, borrower, loan amount, loan program, interest rate, loan term, etc. Transaction data 101 is typically provided in conjunction a request to implement certain documents necessary to conduct the desired real estate financing transaction and is typically supplied by the individual or entity that initiated the request for creating the transaction-related documents. In the most preferred embodiments of the present invention, transaction data 101 is supplied by the initiating party electronically by accessing a secure web site on the Internet and entering the required transaction data 101 into a secure database that is maintained in conjunction with the web site. Then, once captured at the web site, transaction data 101 is transferred in conjunction with a request for documents and is utilized in the remaining process step of diagram 100. In the most preferred embodiments of the present invention, transaction data 101 is packaged and transmitted as an XML file.

Next, profile data 111 is added to the transaction data to provide additional details about the proposed transaction. Profile data 111 includes general information that may be utilized in conjunction with multiple real estate financing transactions. Typically, profile data 111 includes information identifying the person or entity that is originating the transaction, information about the entity funding the loan, the late charges the lender charges, etc. Profile data 111 is typically provided by the person or entity requesting the documents.

The specific loan program identified in conjunction with transactional data 105 is then used to extract all of the forms required for the contemplated transaction from document library 116 to add a loan package (step 115). The loan package includes the specific rules for determining when and under what circumstances various forms should be included in the package as well as instructions for mapping transaction data 101 and profile data 111 to the appropriate locations on the required forms. Steps 110 and 115 are most preferably accomplished via a web service designed and configured to perform the specified tasks.

It should be noted that the forms included in the loan package are a series of templates or pre-formatted documents that include both pre-determined content and areas for variable content known as “Form Fields.” Form Fields are areas on the pre-formatted forms where the actual text to be included is determined by processing transaction data 101 and profile data extracted from profile database 111. In the most preferred embodiments of the present invention, a set of rules in an Extensible Stylesheet Language (XSL) file is used to determine the content to be added to the various forms. Additionally, one or more “Form Rules” will be utilized to quantify whether or not a given form should be included in a given loan package. For example, a prepayment rider form would be included in the loan package only if transaction data 101 included information relative to the inclusion of a prepayment penalty as a contractual provision of the loan.

After the loan package has been implemented, it is posted to a queue (step 120). The most preferred embodiments of the present invention incorporate a first-in, first-out (FIFO) queuing mechanism, but it should be noted that other prioritization methodologies could be employed without departing from the spirit and scope of the present invention.

When the loan package is pushed out of the queue for further processing, a series of loan-related calculations are performed (step 125) using transaction data 101 and the profile data extracted from profile database 111 in step 110. For example, the annual percentage rate (APR), amount financed, amortization schedule, and similar loan-specific elements are calculated and included in the forms. This step also involves the application of a specific set of finance-related rules that are generally consistent across the real estate financing industry. Once the calculations have been completed, the Form Rules and Form Field rules associated with each form in the XML package are processed and values for forms, based on each rule, are determined (step 130).

Once the requested forms have been completed, the XML package is posted by the gateway (step 135). Gateway posts the completed xml to the designated location based up the results of the process (pass/fail). It should be noted that the included gateway can also transmit e-mails, although the most preferred embodiments of the present invention prevent e-mail transmission of completed XML files since the XML files may contain sensitive financial information and e-mail transmission is considered non-secure communication.

After posting, the universal document package 140 is implemented by a document engine. It should be noted that universal document package 140 is now an XML file that includes all data, forms, tools, etc. for accessing and utilizing universal document package 140 in completing the desired real estate financing transaction. It should be noted that the information and data stored in universal document package 140 may be stored in any suitable format and is capable of being output in any necessary format.

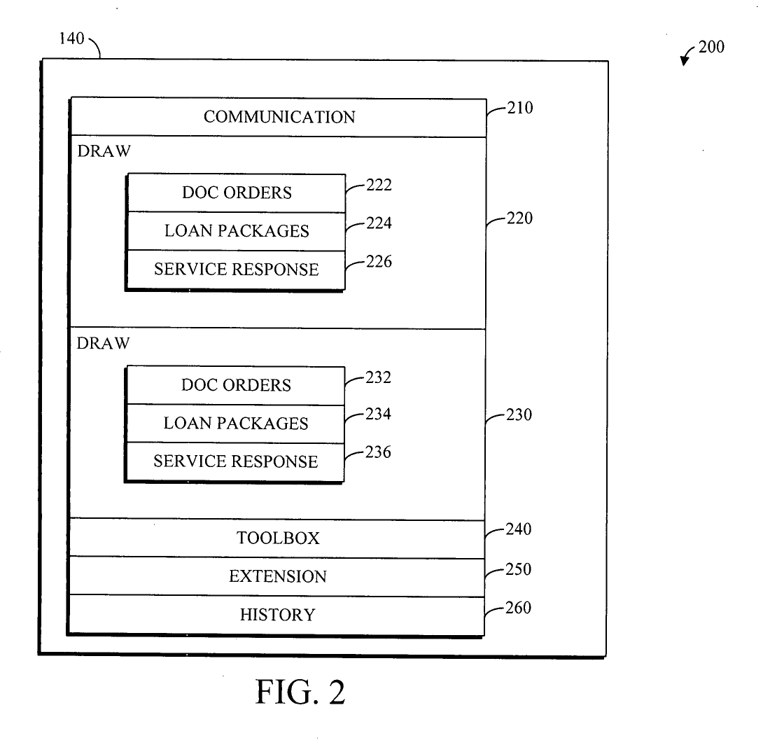

Referring now to FIG. 2, a block diagram of the universal document package 140 of FIG. 1 in accordance with a preferred embodiment of the present invention is depicted. As shown in FIG. 2, universal document package 140 comprises: a communication section 210; a draw section 220; a draw section 230; a toolbox section 240; an extension section 250; and a history section 260. It should be noted that although a universal document package 140 includes both draw sections 220 and 230, certain preferred embodiments may employ only a single draw section 220. The inclusion of multiple draw sections is for illustration purposes since universal document package 140 may have as many draw sections as required.

Communication section 210 contains the information necessary to communicate with the various entities involved in processing universal document package 140 at various steps in the process. For example, communication protocols, posting locations, web site locators, etc. are all specified in communication section 210. In this fashion, the results of the various process steps can be transmitted to the desired location at the appropriate time during the processing cycle.

Draw sections 220 and 230 are collections identifying each draw made for each participant in the processing of universal document package 140. Each time a new set of documents is implemented from universal document package 140, a new draw section (i.e., 220 and 230) is implemented. A “redraw” is drawing the same set of documents again. This allows a re-evaluation of the transaction data, the form field rules and the form rules in order to ensure all data contained in a given document package is accurate and complete.

Each draw section (220 and 230) will contain a doc order section 222, a loan package section 224 and a service response section 226. Doc order section 222 is collection of all of the document orders that have been processed against universal document package 140. Loan package section 224 is a collection containing all of the loan packages that have been drawn against universal document package 140. Service response section 226 is a collection storing the responses from various service providers (credit, flood, title, appraisal, fraud, etc.) involved in the processing of universal document package 140. The service element is repeated for each service involved and includes identifying information as well as the actual response. Additionally, the digital signature information is contained herein.

Each draw section (220 and 230) contains the specific transaction data and the loan package associated with that specific draw along with any services that were requested and applied against that specific draw. In this fashion, if it is necessary to change the transaction data to due changed circumstances, the transaction data is updated and a new draw is implemented. The new draw will include the new data. Each draw section has a digital signature associated with it to ensure the integrity of the loan package. Accordingly, when the transaction data is changed and a new draw is implemented, the new draw (or redraw) will include a new digital signature. In this fashion, it is always possible to examine the transaction data associated with a given loan package for warranty purposes. Accordingly, each service provider can be assured that the representations they have made in conjunction with a given transaction are appropriate to the data upon which the representations and warranties were made.

Toolbox section 240 is the location where the various XSL tools used to process universal document package 140 are stored. The inclusion of the tools used to process universal document package 140 in universal document package 140 allows the data and information to be inserted, extracted and updated in universal document package 140 by different entities and service providers involved in processing universal document package 140. Additionally, toolbox section 240 allows the data contained in universal document package 140 to be translated and presented in any desired format for the various process steps. Finally, since the XSL tools are included in universal document package 140, the right version of the necessary tool is always available during the process. When a given tool is updated in universal document package 140, all draws and loan packages procured with the updated tool will have access to the appropriate tool. This is an improvement over other versions where the tools are stored separately from the loan data and loan transaction.

Extension section 250 is a location for storing extensions to the current standards for implementing universal document packages. By using one or more new XML files, the existing functionality of universal document package 140 can be expanded. Additionally, transaction specific processes and functions can be included.

History section 260 is used to record each transaction, update, and process step that takes place as universal document package 140 is processed. For example, if a data element is updated during the processing of document package 140, the change is noted in history section 260. Additionally, information regarding when it was changed and what user or entity made the change is also recorded. In this fashion, a documentation trail is created for auditing any specific changes and determining if the changes were appropriate and/or authorized.

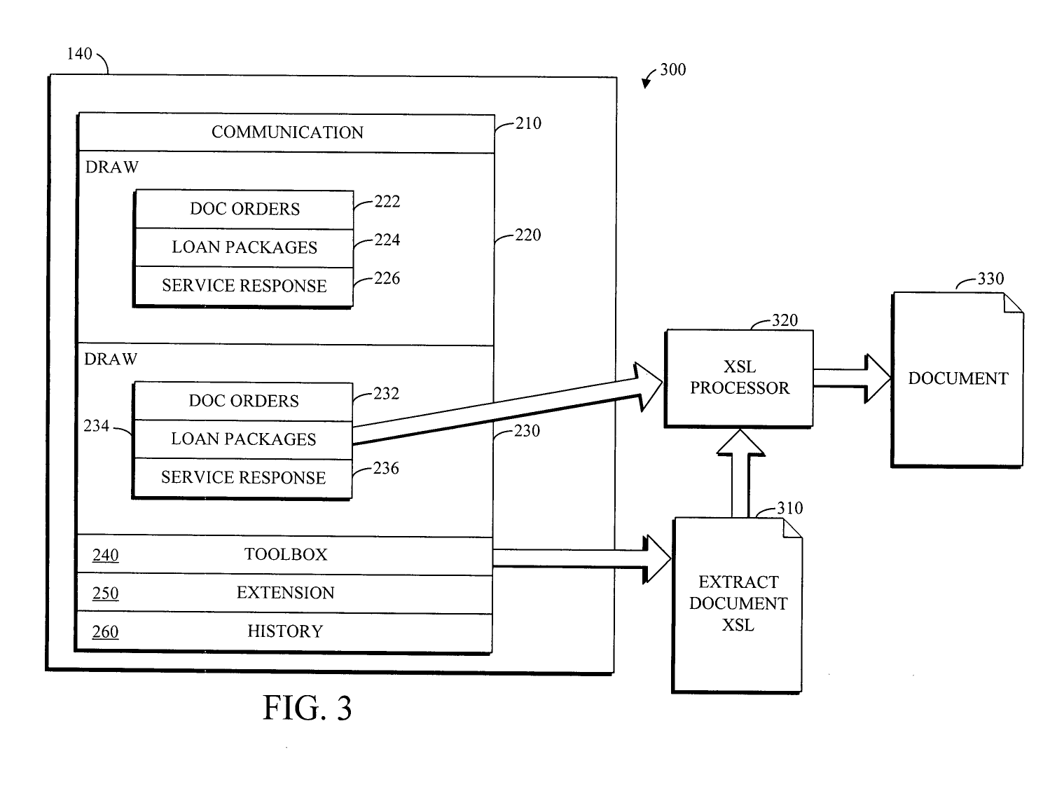

Referring now to FIG. 3, a schematic diagram of a process 300 for extracting information from universal document package 140 of FIG. 2 in accordance with a preferred embodiment of the present invention is depicted. As shown in FIG. 3, XSL instructions for the document extraction process are extracted from tools section 240 into extract document XSL 310. XSL processor 320 is a software program or routine for processing XSL documents. The instructions contained in extract document XSL 320 are loaded into XSL processor 320 and run against universal document package 140. XSL processor 320 identifies the appropriate draw, appropriate loan package, and then identifies the requested form. Finally, XSL processor 320 procures document 330, including the loan-specific data. In the most preferred embodiments of the present invention, document 330 is produced as an XHTML document. As desired, document 330 can be viewed, printed, etc. If the desired form is not found, then XSL processor 320 will return a notification.

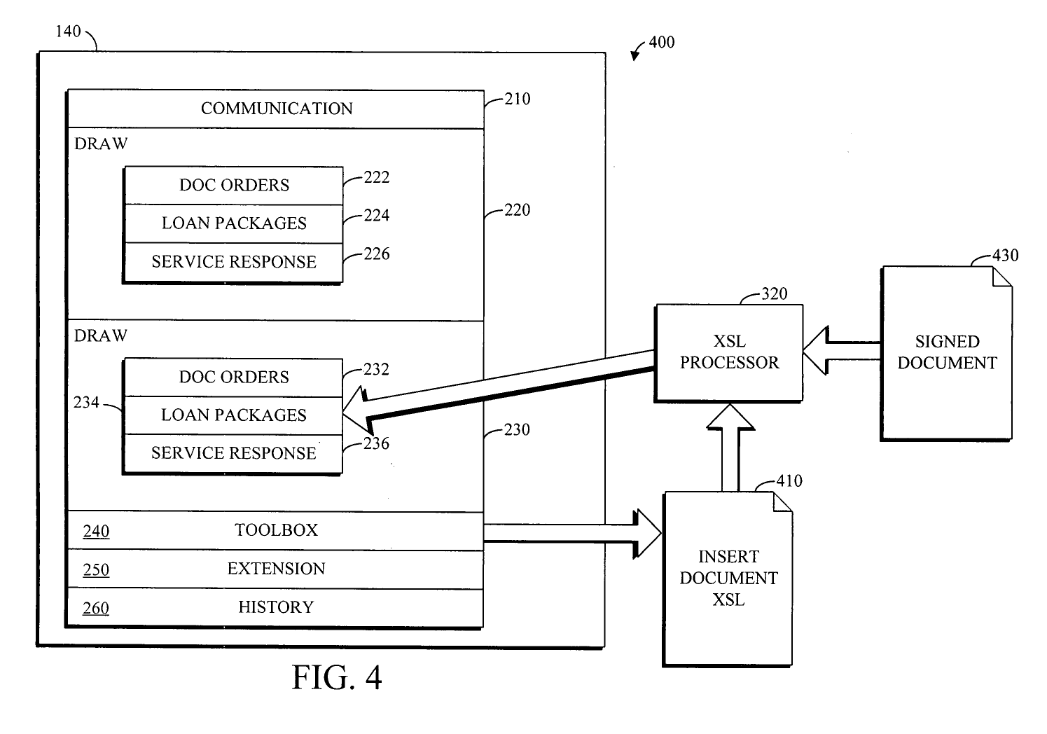

Referring now to FIG. 4, a schematic diagram of a process 400 for inserting a digitally signed document into universal document package 140 of FIG. 2 in accordance with a preferred embodiment of the present invention is depicted. XSL instructions for the document insertion process are extracted from tools section 240 into insert document XSL 410. The instructions contained in extract document XSL 410 are loaded into XSL processor 320 and run against universal document package 140. XSL processor 320 implements a new package element for the appropriate draw and identifies the appropriate loan package for signed document 430. Then XSL processor 320 loads signed document 430 and stores signed document 430 in the XHTML element of the implemented form.

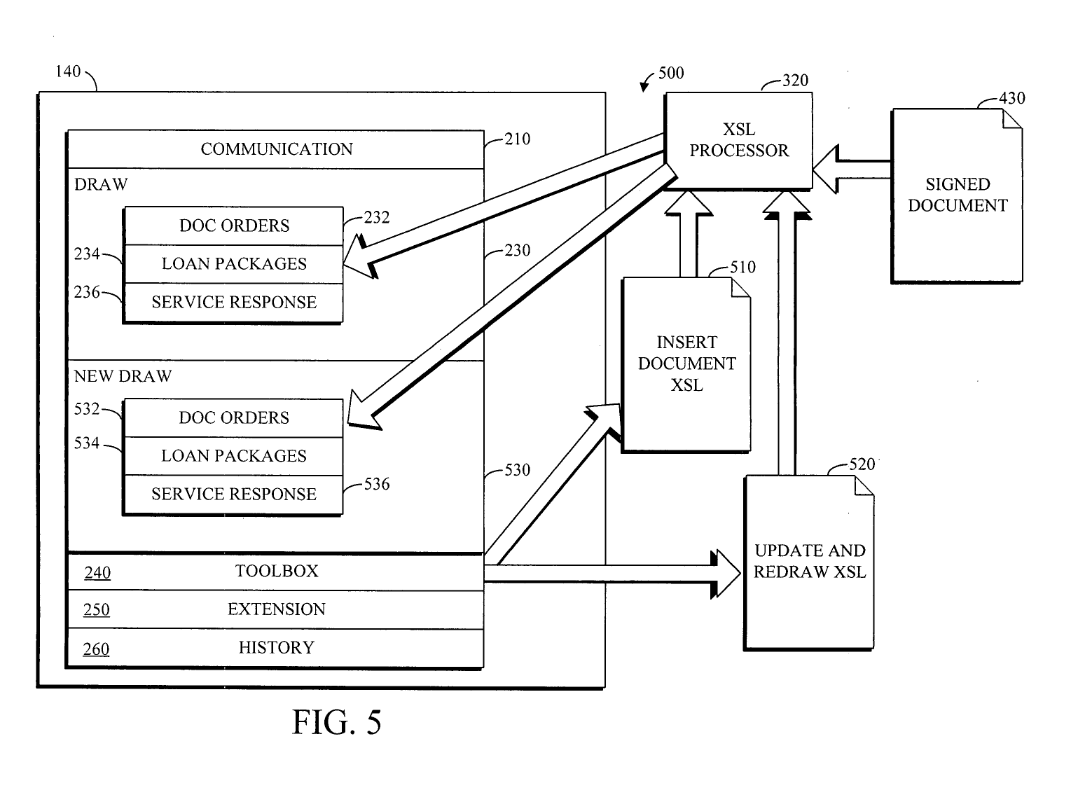

Referring now to FIG. 5, a schematic diagram of a process 500 for updating universal document package 140 of FIG. 2 in accordance with a preferred embodiment of the present invention is depicted. Process 500 is used to illustrate the process of changing source data in universal document package 140. XSL instructions for the document insertion process are extracted from tools section 240 into insert document XSL 510. The instructions contained in extract document XSL 510 are loaded into XSL processor 320 and run against universal document package 140. Then, XSL processor 320 is run against universal document package 140 and implements a new package element for the appropriate draw. XSL processor 320 transfers the old package into the package element of the new package. Then XSL processor 320 loads signed document 430 and stores signed document 430 in the XHTML element of the created form. This ensure that the integrity and congruity of the loan package remain intact, thereby ensuring the viability of the loan package in the secondary market as well.

Next, XSL instructions for the update and redraw process are extracted from tools section 240 into update and redraw document XSL 520. The instructions contained in update and redraw document XSL 520 are loaded into XSL processor 320 and run against universal document processor 140. Then, XSL processor 320 implements new draw 530.

Additionally, universal document package 140 includes a new package element for the appropriate draw. XSL processor 320 transfers the old package into the package element of the new package. Then XSL processor 320 loads signed document 530 and stores signed document 530 in the XHTML element of the implemented form.

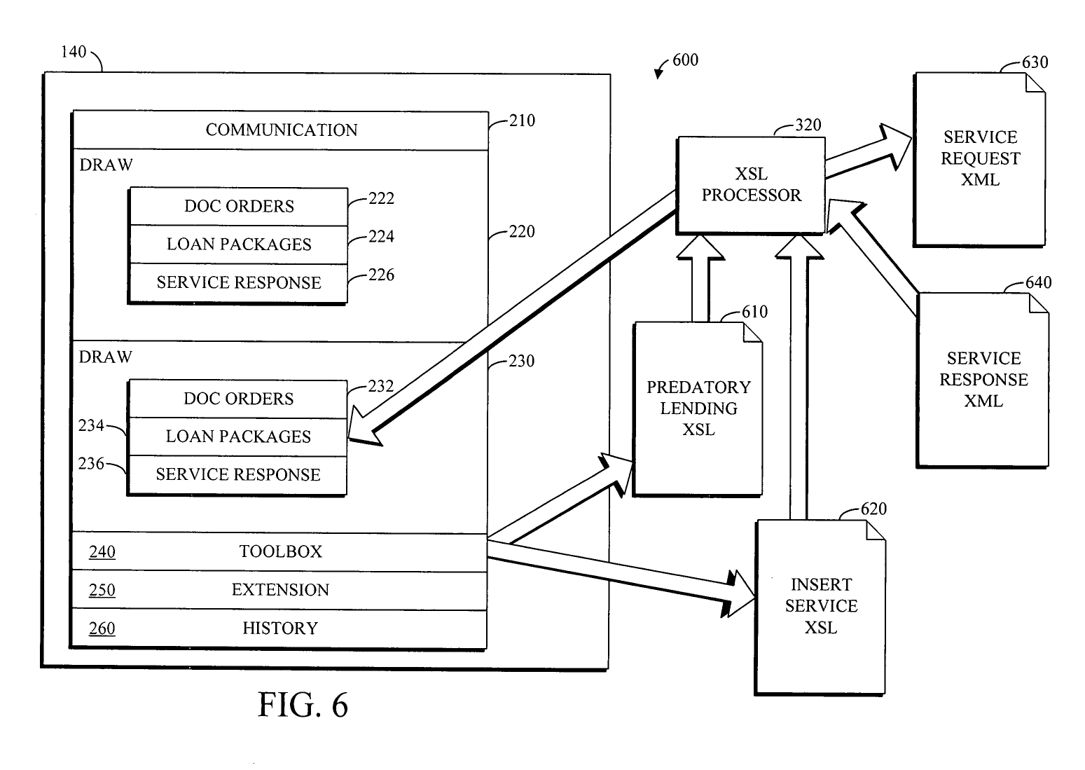

Referring now to FIG. 6, a schematic diagram of a process 600 for requesting loan-specific information from universal document package 140 of FIG. 2, receiving the loan-specific information and then inserting the received information into a universal document package in accordance with a preferred embodiment of the present invention is depicted. Process 600 depicts the process of requesting information from a service provider, receiving the requested information from the service provider, and inserting the requested information into service response 236. The process of inserting, extracting documents, and implementing XML files proceeds in much the same way as described in conjunction with FIGS. 3-6. It should be noted that more than one service request and response may be made and multiple service providers may be used in providing the various services requested.

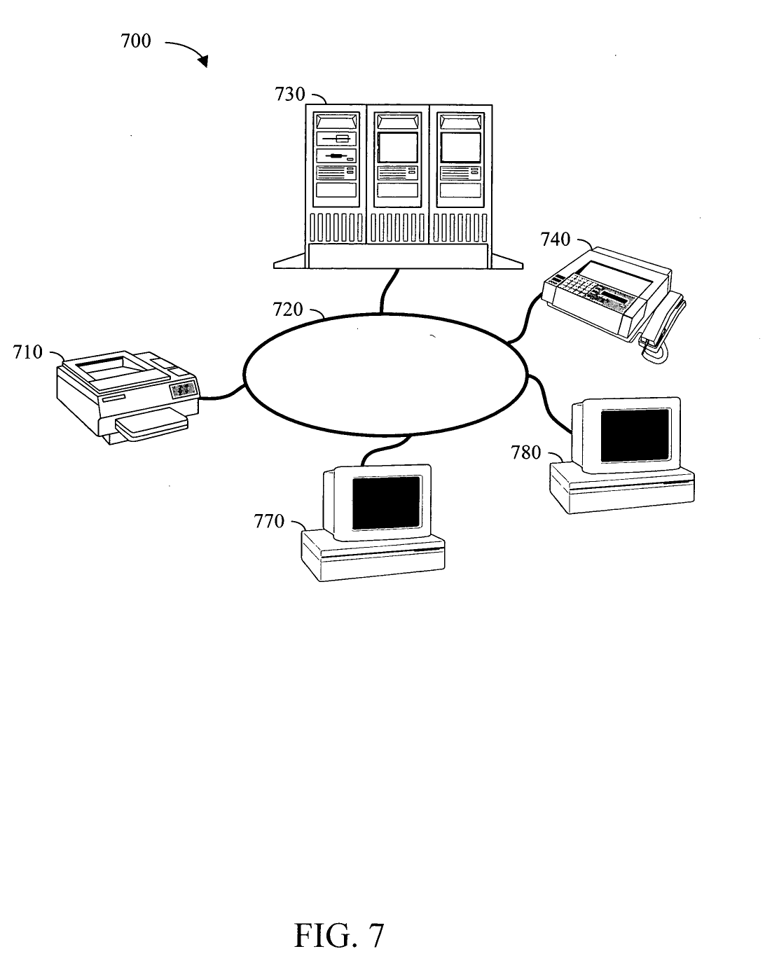

Referring now to FIG. 7, a block diagram of a computer-based system 700 for procuring, deploying, and implementing universal document packages for mortgage processing in accordance with a preferred embodiment of the present invention comprises: a data server 730; an information requesting computer system 770; and an information providing computer system 780, all connected or coupled via a network 720. Additionally, an optional printer 710 and an optional fax machine 740 are shown. Taken together, computer-based system 700 provides a way for financial institutions, brokers, agents, individuals, insurance providers, and the like to more efficiently and effectively manage the mortgage process using universal document packages as described herein in conjunction with the various preferred embodiments of the present invention.

Data server 730 represents a relatively powerful computer system that is made available to information requesting computer system 770 and information providing computer system 780 via network 720. Various hardware components (not shown this FIG.) such as external monitors, keyboards, mice, tablets, hard disk drives, recordable CD-ROM/DVD drives, jukeboxes, fax servers, magnetic tapes, and other devices known to those skilled in the art may be used in conjunction with data server 730. Data server 730 may also provide various additional software components (not shown this FIG.) such as database servers, web servers, firewalls, security software, and the like. The use of these various hardware and software components is well known to those skilled in the art. Given the relative advances in the state-of-the-art computer systems available today, it is anticipated that functions of data server 730 may be provided by many standard, readily available data servers. Depending on the desired size and relative power required for data server 730, storage area network (SAN) technology may also be deployed in certain preferred embodiments of the present invention. Additionally, devices for creating and verifying digital signatures (i.e., electronic signature processing) may also be included.

Information requesting computer system 770 may be any type of computer system known to those skilled in the art that is capable of being configured for use with computer-based system 700 as described herein. This includes laptop computers, desktop computers, tablet computers, pen-based computers and the like. Additionally, handheld and palmtop devices are also specifically included within the description of devices that may be deployed as an information requesting computer system 770. It should be noted that no specific operating system or hardware platform is excluded and it is anticipated that many different hardware and software platforms may be configured to create information requesting computer system 770. As previously explained in conjunction with data server 730, various hardware components and software components (not shown this FIG.) known to those skilled in the art may be used in conjunction with information requesting computer system 770. It should be noted that in the most preferred embodiments of the present invention, information requesting computer system 770 is linked to its own LAN or WAN and has access to its own data server (not shown this FIG.). It should be noted that the use of XML and XSL allows the methods of the present invention to be platform independent, something that has not been achieved prior to the disclosure of the present invention.

Similarly, information providing computer system 780 may be any type of computer system known to those skilled in the art that is capable of being configured for use with computer-based system 700 as described herein. This includes laptop computers, desktop computers, tablet computers, pen-based computers and the like. Additionally, handheld and palmtop devices are also specifically included within the description of devices that may be deployed as an information providing computer system 780. It should be noted that no specific operating system or hardware platform is excluded and it is anticipated that many different hardware and software platforms may be configured to create information providing computer system 780. As previously explained in conjunction with data server 730, various hardware and software components (not shown this FIG.) known to those skilled in the art may be used in conjunction with information providing computer system 780. It should be noted that in the most preferred embodiments of the present invention, information requesting computer system 780 is linked to its own LAN or WAN and has access to its own data server (not shown this FIG.).

Network 720 is any suitable computer communication link or communication mechanism, including a hardwired connection, an internal or external bus, a connection for telephone access via a modem or high-speed T1 line, radio, infrared or other wireless communications, private or proprietary local area networks (LANs) and wide area networks (WANs), as well as standard computer network communications over the Internet or an internal network (e.g. “intranet”) via a wired or wireless connection, or any other suitable connection between computers and computer components known to those skilled in the art, whether currently known or developed in the future. It should be noted that portions of network 720 may suitably include a dial-up phone connection, broadcast cable transmission line, Digital Subscriber Line (DSL), ISDN line, or similar public utility-like access link.

In the most preferred embodiments of the present invention, network 720 represents and comprises a standard Internet connection between the various components of computer-based system 700. Network 720 provides for communication between the various components of computer-based system 700 and allows for relevant information to be transmitted from device to device. In this fashion, a user of computer-based system 700 can quickly and easily gain access to the relevant data and information utilized to procure and deploy universal document packages as described in conjunction with the preferred embodiments of the present invention. Regardless of physical nature and topology, network 720 serves to logically link the physical components of computer-based system 700 together, regardless of their physical proximity. This is especially important because in many preferred embodiments of the present invention, data server 730, information requesting computer system 770, and information providing computer system 780 will be geographically remote and separated from each other.

In general, data server 730 processes requests for various transactions between information requesting computer system 770 and information providing computer system 780. A typical transaction may be represented by a request for information relative to an existing or new mortgage transaction, an existing or new loan application for a mortgage transaction, or information request regarding a specific set of circumstances for a new or existing mortgage holder. In this case, a request for information is sent from information requesting computer system 770 to data server 730. Data server 730 processed the request, formats the request for processing by and transfers the requested request to information requesting computer system 770. The requested information may include queries relative to organizations and individuals seeking mortgages as well as information regarding the actual or proposed mortgage-related transactions.

In some case, the requested information may be fully contained and accessible by making requests to data server 730. However, in certain preferred embodiments of the present invention, a request for information sent from information requesting computer system 770 to data server 730 may require additional data or information not directly available to data server 730. In that case, data server 730 may request and receive data and information from information providing computer system 780 relative to a specific request from requesting computer system 770 to data server 730.

It should be noted that the roles of information requesting computer system 770 and information providing computer system 780 may be interchanged, depending on which system initiates the request. Additionally, it should be noted that while FIG. 7 shows only a single information requesting computer system 770 and a single information providing computer system 780, it is anticipated that the most preferred embodiments of the present invention will comprise hundreds and even thousands of information requesting computer systems 770 and computer systems 780.

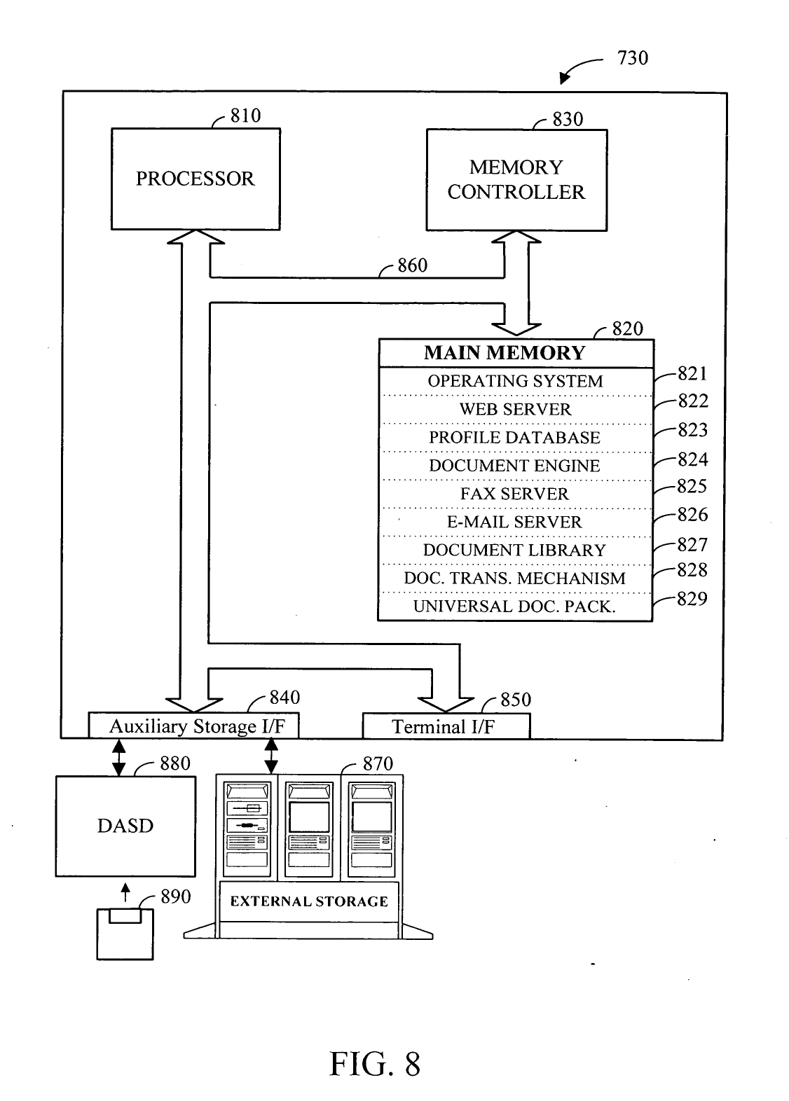

In the most preferred embodiments of the present invention, multiple information requesting computer systems 770 and multiple information providing computer systems 780 will all be configured to communicate with data server 730 and with each other via network 720. In addition, the most preferred embodiments of the present invention include an Application Service Provider (ASP) environment where data server 730 is operated as a clearinghouse in a hosted operation. In this fashion, multiple information requesting computer systems 770 and information providing computer systems 780 will have access to data server 730 on a subscription or pay-for service basis. Data server 730 is further described below in conjunction with FIG. 8 below.

Optional printer 710 and an optional fax machine 740 are standard peripheral devices that may be used for transmitting or outputting paper-based mortgage documents, notes, financial transactions, reports, etc. in conjunction with the mortgage-related queries and transactions processed by computer-based system 700. Optional printer 710 and an optional fax machine 740 may be directly connected to network 720 or indirectly connected via any or all of information requesting computer systems 770, information providing computer systems 780, and/or data server 730. Finally, it should be noted that optional printer 710 and optional fax machine 740 are merely representative of the many types of peripherals that may be utilized in conjunction with computer-based system 700. It is anticipated that other similar peripheral devices will be deployed in the various preferred embodiment of the present invention and no such device is excluded by its omission in FIG. 7.

Referring now to FIG. 8, a data server 730 in accordance with a preferred embodiment of the present invention is a commercially available computer system such as a Linux-based computer system, IBM compatible computer system, or Macintosh computer system. However, those skilled in the art will appreciate that the methods and apparatus of the present invention apply equally to any computer system, regardless of whether the computer system is a traditional “mainframe” computer, a complicated multi-user computing apparatus or a single user device such as a personal computer or workstation.

Data server 730 suitably comprises at least one Central Processing Unit (CPU) or processor 810, a main memory 820, a memory controller 830, an auxiliary storage interface 840, and a terminal interface 850, all of which are interconnected via a system bus 860. Note that various modifications, additions, or deletions may be made to data server 730 illustrated in FIG. 8 within the scope of the present invention such as the addition of cache memory or other peripheral devices. FIG. 8 is not intended to be exhaustive, but is presented to simply illustrate some of the salient features of data server 730.

Processor 810 performs computation and control functions of data server 730, and comprises a suitable central processing unit (CPU). Processor 810 may comprise a single integrated circuit, such as a microprocessor, or may comprise any suitable number of integrated circuit devices and/or circuit boards working in cooperation to accomplish the functions of a processor. Processor 810 suitably executes one or more software programs contained within main memory 820.

Auxiliary storage interface 840 allows data server 730 to store and retrieve information from auxiliary storage devices, such as external storage mechanism 870, magnetic disk drives (e.g., hard disks or floppy diskettes) or optical storage devices (e.g., CD-ROM). One suitable storage device is a direct access storage device (DASD) 880. As shown in FIG. 8, DASD 880 may be a floppy disk drive that may read programs and data from a floppy disk 890. It is important to note that while the present invention has been (and will continue to be) described in the context of a fully functional computer system, those skilled in the art will appreciate that the mechanisms (particularly document engine 824 and/or document transaction mechanism 828 of FIG. 8) of the present invention are capable of being distributed in conjunction with signal bearing media as one or more program products in a variety of forms, and that the various preferred embodiments of the present invention applies equally regardless of the particular type or location of signal bearing media used to actually carry out the distribution. Examples of signal bearing media include: recordable type media such as floppy disks (e.g., disk 890) and CD ROMS, and transmission type media such as digital and analog communication links, including wireless communication links.

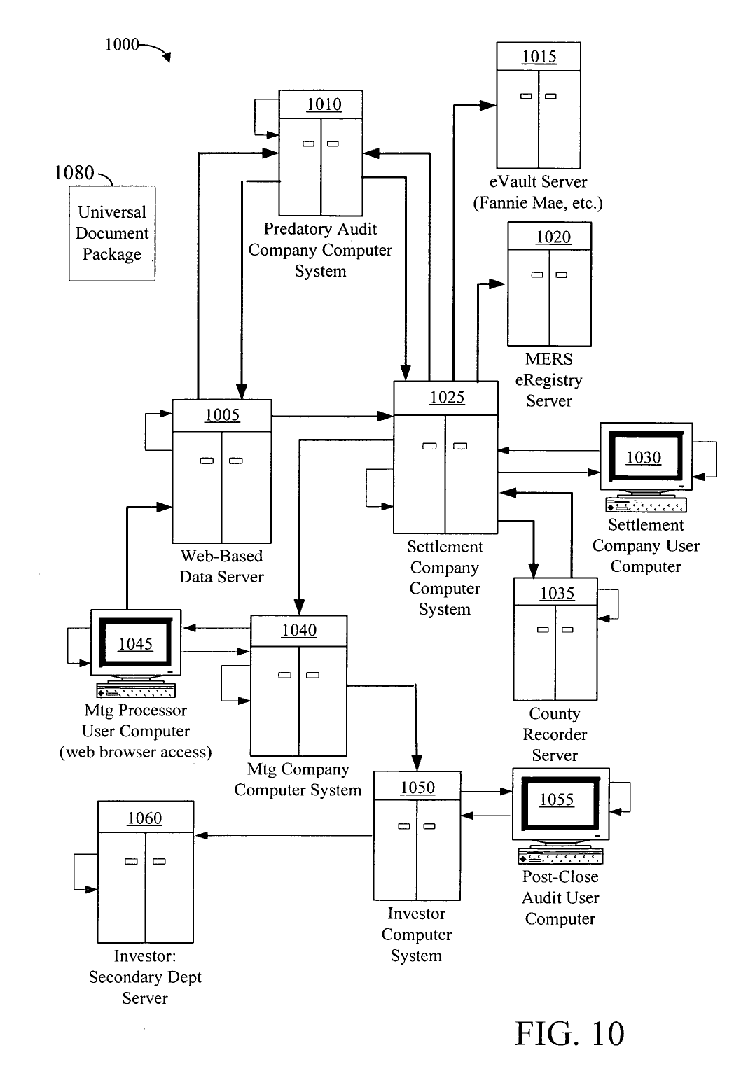

In the most preferred embodiments of the present invention, various preferred embodiments of the program product may be configured to: communicate with the various entities involved in a typical real estate investment transaction; identify the transaction data; add profile data from a profile database; procure a loan package using a document library; and use XML and XSL to implement, update and transmit one or more universal document packages. In this fashion, the appropriate entities (i.e., brokers, lender, title companies, insurance companies, etc.) can utilize the program product to initiate and complete a wide variety of real estate finance transactions. Similarly, a program product in accordance with one or more preferred embodiments of the present invention can also be configured to perform substantially all of the steps depicted and described in conjunction with FIG. 10 below for a specific real estate financing transaction and other similar transactions well known to those skilled in the art.

Memory controller 830, through use of an auxiliary processor (not shown) separate from processor 810, is responsible for moving requested information from main memory 820 and/or through auxiliary storage interface 840 to processor 810. While for the purposes of explanation, memory controller 830 is shown as a separate entity; those skilled in the art understand that, in practice, portions of the function provided by memory controller 830 may actually reside in the circuitry associated with processor 810, main memory 820, and/or auxiliary storage interface 840.

Terminal interface 850 allows users, system administrators and computer programmers to communicate with data server 730, normally through separate workstations or through stand-alone computer systems such as information requesting computer systems 770 and information providing computer systems 780 of FIG. 7. Although data server 730 depicted in FIG. 8 contains only a single main processor 810 and a single system bus 860, it should be understood that the present invention applies equally to computer systems having multiple processors and multiple system buses. Similarly, although the system bus 860 of the preferred embodiment is a typical hardwired, multi-drop bus, any connection means that supports bi-directional communication in a computer-related environment could be used.

Main memory 820 suitably contains an operating system 821, a web server 822, profile database 823, a document engine 824, a fax server 825, an e-mail server 826, a document library 827, a document transaction mechanism 828, and a universal document package 829. The term “memory” as used herein refers to any storage location in the virtual memory space of data server 730.

It should be understood that main memory 820 may not necessarily contain all parts of all components shown. For example, portions of operating system 821 may be loaded into an instruction cache (not shown) for processor 810 to execute, while other files may well be stored on magnetic or optical disk storage devices (not shown). In addition, although document transaction mechanism 828 is shown to reside in the same memory location as operating system 821, it is to be understood that main memory 820 may consist of multiple disparate memory locations. It should also be noted that any and all of the individual components shown in main memory 820 may be combined in various forms and distributed as a stand-alone program product. Finally, it should be noted that additional components, not shown in this figure may also be included.

For example, most preferred embodiments of the present invention will include a security and/or encryption facility for verifying access to the data and information contained in and transmitted by data server 730. The security facility may be incorporated into operating system 821 or document transaction mechanism 828. Additionally, the security mechanism may also provide encryption capabilities for computer-based system 700, thereby enhancing the robustness of computer-based system 700. Once again, depending on the type and quantity of information stored in profile database 823 and document library 827, the security mechanism may provide different levels of security and/or encryption for different computer systems 770 and 780. Additionally, the level and type of security measures applied by the security system may be determined by the nature of a given request and/or response. In some preferred embodiments of the present invention, the security system may be contained in or implemented in conjunction with certain hardware components (not shown this FIG.) such as hardware-based firewalls, switches, dongles, and the like.

Operating system 821 includes the software that is used to operate and control data server 730. In general, processor 810 typically executes operating system 821. Operating system 821 may be a single program or, alternatively, a collection of multiple programs that act in concert to perform the functions of an operating system. Any operating system known to those skilled in the art may be considered for inclusion with the various preferred embodiments of the present invention.

Web server 822 may be any web server application currently known or later developed for communicating with web clients over a network such as the Internet. Examples of suitable web servers 822 include Apache web servers, Linux web servers, and the like. Additionally, other vendors have developed or will develop web servers that will be suitable for use with the various preferred embodiments of the present invention. Finally, while depicted as a single device, in certain preferred embodiments of the present invention web server 822 may be implemented as a cluster of multiple web servers, with separate hardware and software systems. This configuration provides additional robustness for system uptime and reliability purposes. Regardless of the specific form of implementation, Web server 822 provides access, including a user interface, to allow individuals and entities to interact with document transaction mechanism 828, including via network 720 of FIG. 7.

As previously explained in conjunction with FIG. 1, profile database 823 is representative of any suitable database known to those skilled in the art. In the most preferred embodiments of the present invention, profile database 823 is a Structured Query Language (SQL) compatible database file capable of storing information relative to the various loan programs, interest rates, and real estate financing transaction entities, including names, addresses, account preferences, etc. While profile database 823 is shown to be residing in main memory 820, it should be noted that profile database 823 may also be physically stored in a location other than main memory 820. For example, profile database 823 may be stored on external storage device 870 or DASD 880 and coupled to data server 730 via auxiliary storage I/F 840.

Document engine 824 is most preferably a software application configured to coordinate the movement of each document request within computer-based system 700. Specifically, document engine 824 is configured with a queue to store and forward document requests as the various activities associated with the document request take place. Additionally, document engine 824 comprises a calculator that calculates data for inclusion on the forms contained in a given document request. Document engine 824 also performs rules processing activities for assembling various documents that are provided in response to a document request. Document engine 824 also incorporates a gateway for posted completed files to the designated locations. As previously explained, the most preferred embodiments of the present invention utilize XML for the document file format.

Fax server 825 is any fax server known to those skilled in the art and is configured to receive inbound fax messages and to transmit outbound fax messages. Fax server 825 may format and transmit any data processed by computer-based system 700 of FIG. 7 and make it available for use by any other component of computer-based system 700 of FIG. 7. Additionally, fax server 825 may process the data received and send it directly to document engine 824 and make the incoming data for further processing by computer-based system 700, including processing universal document package 829 by document engine 824 and document transaction mechanism 828.

While not required, the most preferred embodiments of data server 730 of FIG. 7 will typically include an e-mail server 826. E-mail server 826 is any e-mail server application capable of being configured and used to send and receive various status messages and updates to data server 730 and between computer systems 770 or 780 of FIG. 7 via e-mail, as may be necessary to enhance the overall process of completing various real estate financing transactions as described herein. This includes the generation of automated e-mail messages relating to the status of real estate transactions performed in accordance with the various preferred embodiments of the present invention.

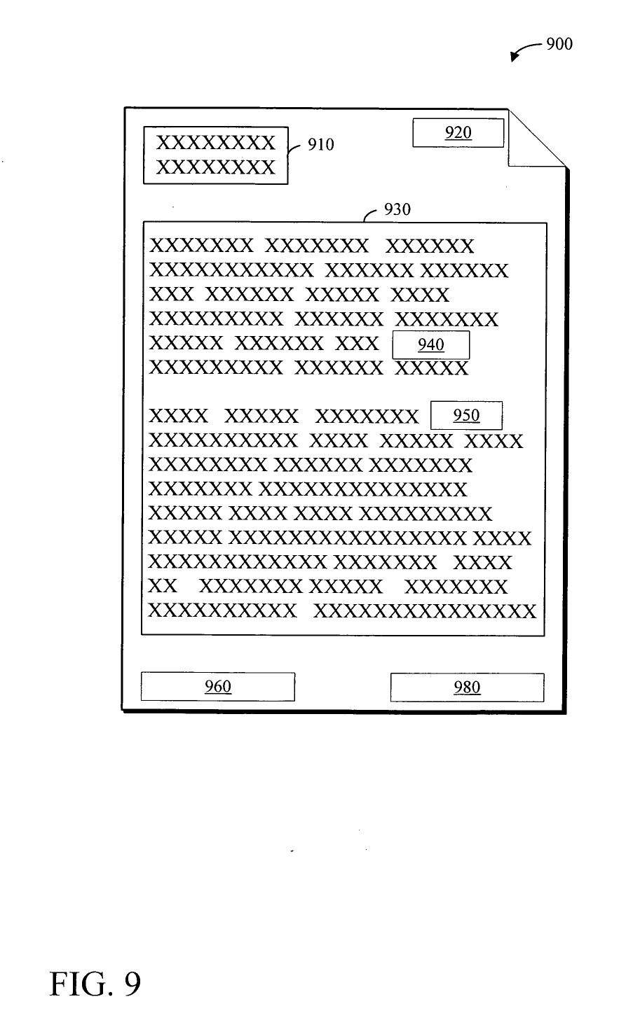

As previously explained, document library 827 contains forms, rules, form fields, mapping data for the form fields, etc. This information is used in conjunction with profile database 823, document engine 824, and document transaction mechanism 828 to procure one or more universal document packages 829. The use of form fields and form rules is further explained below in conjunction with FIG. 9.

Document transaction mechanism 828 is most preferably a web-service software application program configured to assemble universal document packages 829 as described in FIG. 1. Document transaction mechanism 828 coordinates with document engine 824 to take the document packages implemented by document engine 824, add the various tools to be used by the various participants in the contemplated real estate transaction and procure a universal document package 829. In this fashion, the users of computer-based system 700 of FIG. 7 can access the functionality of computer-based system 700 to simplify real estate financing transactions. Accordingly, document transaction mechanism 828 is also configured to coordinate the tracking and reporting on the status of a given universal document package and real estate financing transaction and other similar tasks as may be required to successfully implement the preferred embodiments of the present invention.

Referring now to FIG. 9, a sample document 900 derived from a universal document package, where the universal document package has been previously procured as explained in conjunction with FIG. 2 is depicted. Sample document 900 is representative of a document utilized in a typical real estate financing transaction. As shown in FIG. 9, sample document 900 contains text blocks 910 and 930 and form fields 920, 940, 950, 960, and 980. Text blocks 910 and 930 contain standard text that will be printed on each and every form 900 while form fields 920, 940, 950, 960, and 980 represent variable text that may vary from time to time as determined by the transaction data and profile data associated with a given universal document package as previously explained in conjunction with FIG. 2. It should be noted that a given document 900 may be a single page document or a multi-page document and may include any number of form fields.

Form fields 920, 940, 950, 960, and 980 are specific areas on document 900 where variable text (i.e., text that changes on each loan) will appear. Each of form fields 920, 940, 950, 960, and 980 have both an associated form field rule for populating the form field and a value for the form field that was determined by applying the form field rule for each form field.

The form field rule associated with each of form fields 920, 940, 950, 960, and 980 is most preferably an XSL file that is applied to the dataset associated with the document request for document 900, thereby calculating a value for each form field. For example, in FIG. 9, form field 960 may be a form field for specifying the name of the borrower. Accordingly, the form field rule for form field 960 will programmatically take the borrower's last name, add a comma and a space, add the borrower's first name, and if there is a middle name, add a space, then the first letter of the middle initial and a period. This information is then inserted into document 900 in each place where form field 960 appears. Similarly, form field 920 may be a form field for specifying the loan number for the loan identified in document 900.

It should be noted that a given form field can appear on more than one form in a document set. The value for each form field is determined and then the value for the form field is applied to each individual form required in conjunction with each document request. Accordingly, if the value of a given form field is changed as a result of subsequent processing, all forms that incorporate that form field are automatically updated. Additionally, each form field also has a formatting attribute or flag associated with it that allows the data in the form field to be converted to various industry standard formats. Accordingly, the data contained in any given form field can be mapped to the same element/attribute in the target documents, using the presentation and format of the target document.

While many form field rules are as simple as “populate the value with the loan amount,” other, more complicated form field rules may be employed. For example, form field 950 may be a form field that indicates the lowest rate possible for a loan with an adjustable interest rate. In this case, the form field rule associated with form field 950 will be a calculation similar to this, “the greater of the floor and the initial interest rate minus the maximum rate change.” In this fashion, each document 900 can be customized to a significant level, allowing the document to be adapted for use in various loan programs. By implementing one or more form fields in document 900, a single reusable value can be evaluated or calculated once and then used to provide relevant information for many forms in the same real estate financing transaction.

Each document 900 is procured from a form file that contains formatted text that appears on every form (like a template). In addition, each form file has an associated mapping file to indicate where each form field should appear on the document procured from the form file and how the form field should be formatted (currency, text, etc.). Finally, each form has its collection of “form rules” that can filter the form. A form rule is a document level filter to indicate whether or not a form should be included in response to a given document request. Like the form fields, each form rule has both an associated rule (XSL file) and a value. The value for the form rule is assigned by applying the form rule's XSL file against the dataset deployed in response to a given document request. The value of the form rule is applied to each applicable form and a given form rule can appear on more than one form.

The application of form rules allows for the inclusion of the appropriate forms in response to a given request. For example, if the document package procured in response to a document request contains a first Deed to be used if the lien is in first position and a second Deed to be used if the lien is in second position, the first form in the package will have a form rule for printing only if the lien is in the first position. The second form in the package will have a different form rule that specifies printing only if the lien is in the second position. Using form rules in this fashion allows the universal document package to contain all of the forms that might be necessary for any given transaction.

Then, by applying the form rules associated with the forms in the package, only the applicable forms are available for viewing or printing by the user of the system. Any forms deemed non-applicable can also be reviewed by examining the XSL file for each form rule to determine why they weren't included in the document package. Since a given form file can have multiple form rules associated with it, the results of each form rule are combined in a logical “or” operation so that if any one filter disqualifies a form from inclusion, the form will be filtered out of the document package no matter what the results from the other form rules may be. The form file template and associated mapping file are stored as XHTML files so that each file can be easily viewed and populated using just an XSL processor.

It should be noted that the present invention procures documents in a way that is significantly different than the methods used in current processes. In general, existing form procurement processes populate forms using a script file and a template file. The template file has all of the text that doesn't change. The script file is a computer program that calculates all of the data elements needed to populate the form, one area at a time. The script file is run against the template and a final form is procured. This process has been adopted largely because the dominant format for document templates is based upon PCL (HP's Printer Control Library). This format requires a script file to be used to populate the form. If the data that was used to populate the form changes, the script file must be executed again using proprietary software and both the template file and the script file. Additionally, in currently implemented practices (prior to the disclosure of the present invention), each script file is independent so that the coding using to populate a given form may not be reused in populating another form.

In contrast, in the present invention, the rules for populating form fields and form rules are included with the form field itself, so the form field only has to be coded once and can be reused for all forms in the universal document package. Additionally, if the value of a rule changes, the forms can be updated without proprietary software by applying an XSL file to populate the form field values on the form using the mapping file associated with the Form. Another advantage of the self-contained approach of the present invention is by including the mapping for the form fields and including the rules for populating the form fields in the form fields, the form fields and associated forms can be regenerated using only an XSL processor anywhere, by anyone with an XSL processor. Everything needed to re-populate the forms is included in the universal document package.

In this fashion, by including form fields and applying form rules for many different forms, while normalizing the specific rules and values, the amount of storage space required to hold all of the information for populating a given form is significantly reduced. The XHTML format of the forms included in the universal document package allows the forms to have a tamper-proof digital signature applied. The rules for the form fields and the form rules are also in XSL so the source fields that were used to determine the value of each form rule can be identified without having to decompile any code. By having each of the values for each of the form fields, the data that appears on the form can be retrieved without having to check each form. Finally, the same form field data, appearing on different forms in the document package, will always be consistent since each form in the universal document package is using the same form field value to derive the content for any given form.

Referring now to FIG. 10, a representative computer-based system 1000, suitable for initiating and completing a routine real estate financing transaction, utilizing a universal document package 1080 in accordance with a preferred embodiment of the present invention, is depicted. Computer-based system 1000 includes Web-Based Data Server 1005, Predatory Audit Company Computer System 1010, Settlement Company Computer System 1025, Settlement Company User Computer 1030, Mortgage Company Computer System 1040, Mortgage Processor User Computer 1045, Investor Computer System 1050, Post-Close Audit User Computer 1055, Investor Secondary Dept. Server 1060, and a universal document package 1080. Those skilled in the art will recognize that the various computer systems and components identified in FIG. 10 are a specific embodiment derived from the more general computer-based system described in conjunction with FIG. 7 and that the adaptation shown in FIG. 10 is merely representative of one such embodiment.

Additionally, it should be noted that each of the various computer systems and servers shown in FIG. 10 may also include additional components not depicted in FIG. 10. For example, additional user workstations, although not shown, may be attached to any and/or all of the systems and servers shown in FIG. 10. Additionally, although not explicitly depicted in FIG. 10, those skilled in the art will recognize that the connection between the various components shown in FIG. 10 may be accomplished using various methods and components, including those used to describe network 720 of FIG. 7.

For purposes of the following description, the processes of extracting data, inserting data, updating data, “drawing” and “re-drawing” documents are performed substantially as described in conjunction with FIGS. 2-6. Additionally, it should be understood that the actual documents produced from universal document package 1080 may be produced in any industry standard format, depending on the specific needs of the entity procuring the documents. Accordingly, the actual document format for a given document or documents may be different for each entity or the same document format for certain documents and certain entities. All industry standard document formats may be procured from a given universal document package 1080.

Processing of universal document package 1080 using computer-based system 1000 begins when, for example, a loan officer at a mortgage company uses Mortgage Processor User Computer 1045 to request one or more documents for initiating a desired real estate financing transaction from Web-Based Data Server 1005. Upon receiving the transaction data from Mortgage Processor User Computer 1045, Web-Based Data Server 1005 procures universal document package 1080 and then forwards universal document package 1080 to Predatory Audit Company Computer System 1010 for auditing.

Upon receiving universal document package 1080, Predatory Audit Company Computer System 1010 extracts data from universal document package 1080 into the appropriate format for auditing review and performs the requisite audit of the data. After completing the audit, Predatory Audit Company Computer System 1010 inserts the audit results into universal document package 1080. Additionally, Predatory Audit Company Computer System 1010 also inserts a document certifying that the loan passed audit. Finally, Predatory Audit Company Computer System 1010 adds digital signatures and then forwards universal document package 1080 to Web-Based Data Server 1005.

Web-Based Data Server 1005 then forwards universal document package 1080 to Settlement Company Computer System 1025. Settlement Company Computer System 1025 extracts data from universal document package 1080 and deploys an order requesting settlement review for closing the loan. A user of Settlement Company User Computer 1030 requests the requisite closing documents from Settlement Company Computer System 1025. Upon receiving the document request, Settlement Company Computer System 1025 extracts the requested documents from universal document package 1080 and sends the requested documents to Settlement Company User Computer 1030. The user of Settlement Company User Computer 1030 completes the necessary documents (e.g. HUD-1, Escrow instructions, etc.) and then returns the completed documents to Settlement Company Computer System 1025 for insertion into universal document package 1080.

Settlement Company Computer System 1010 inserts documents and updates the data contained in universal document package 1080. Settlement Company Computer System 1010 then “redraws” the funding documents, thereby incorporating the updated data in universal document package 1080. After the update, Settlement Company Computer System 1025 posts universal document package 1080 to Predatory Audit Company Computer System 1010 to allow the auditor to re-audit the loan.

Predatory Audit Company Computer System 1010 extracts the data from universal document package 1080 into their desired format from second draw, previously deployed by Settlement Company Computer System 1025. A user of Predatory Audit Company Computer System 1010 audits the extracted data and inserts the audit results into universal document package 1080. Next, Predatory Audit Company Computer System 1010 inserts a document certifying that the loan passed the audit. Finally, Predatory Audit Company Computer System 1010 adds digital signatures to the data used in audit (the draw), to their audit results, and their inserted certificate and then sends universal document package 1080 to Settlement Company Computer System 1025.

Settlement Company Computer System 1025 extracts the necessary document or documents from universal document package 1080 in the desired format. In this case, the document format is most preferably an industry standard “eNote SMART Doc” format as promulgated by MISMO. Settlement Company Computer System 1025 then posts the eNote SMART Doc to eVault Server 1015. Settlement Company Computer System 1025 also extracts the industry standard eRegistry transaction from universal document package 1080 and posts the eRegistry transaction and eNote SMART Doc to eRegistry (MERS) Server 1020.

Then, Settlement Company Computer System 1025 extracts specific documents from universal document package 1080 for recording the real estate financing transaction at the County Recorder's Office. In the most preferred embodiments of the present invention, the recordable documents are also procured in the industry standard SMART Docs format. Settlement Company Computer System 1025 posts Recordable SMART Docs to County Recorder Server 1035. County Recorder Server 1035 then records the recordable documents and sends the recorded documents to Settlement Company Computer System 1025. Settlement Company Computer System 1025 then inserts the recorded documents into universal document package 1080.

Settlement Company Computer System 1025 will then transmit universal document package 1080 to Mortgage Company Computer System 1040 where Mortgage Company Computer System 1040 extracts data from universal document package 1080 and creates a funding application. Based on the specific requirements of the loan, Mortgage Company Computer System 1040 also inserts any required loan-specific data into the funding application.

The loan officer will then request the funding documents via Mortgage Processor User Computer 1045. Mortgage Company Computer System 1040 will extract the requested funding document or documents from universal document package 1080. In the most preferred embodiments of the present invention, the funding documents will be provided to Mortgage Company Computer System 1040 in an industry standard format such as the “SMART Doc” format as promulgated by MISMO. After receiving the funding document or documents (typically, an industry standard HUD-1 form) from Mortgage Company Computer System 1040, the loan officer can review the funding documents using Mortgage Processor User Computer 1045. and approve the funding, if appropriate. After receiving notice of funding approval, Mortgage Company Computer System 1040 inserts the required funding data (i.e., check number, check amount, etc.) into universal document package 1080 and applies a digital signature to the funding data, thereby authenticating the funding transaction. After applying the digital signature, Mortgage Company Computer System 1040 transmits universal document package 1080 to Investor Computer System 1050.

Upon receipt of universal document package 1080 by Investor Computer System 1050, an investor auditor requests the appropriate documents and data to perform a post-close audit. Upon request, Investor Computer System 1050 extracts the required audit-related data and documents from universal document package 1080. The investor auditor uses the extracted documents and data to audit the loan for completeness and compliance with investor policies. Upon audit approval, Investor Computer System 1050 forwards universal document package 1080 to Secondary Dept Server 1060. At this point, Secondary Dept Server 1060 extracts the required data into Secondary Import transaction format.

Secondary Dept Server 1060 inserts data into the computer system associated with Secondary Dept Server 1060. This allows an investor or investor entity to package one or more loans to create a pool of similar loans to sell as an investment in the secondary market. Various private and quasi-governmental agencies purchase these pools of loans and the investor can use the proceeds from the sell of the pool of loans to make additional loans. Secondary Dept Server 1060 stores universal document package 1080 for later use as necessary.

In summary, the present invention provides broad application of a unique business process where various entities including lenders, insurance companies, title companies, mortgage brokers, attorneys and the like are all benefited and served by the methods and integrated processes comprehended by the various preferred embodiments of the present invention.

Lastly, it should be appreciated that the illustrated embodiments are preferred exemplary embodiments only, and are not intended to limit the scope, applicability, or configuration of the present invention in any way. Rather, the foregoing detailed description provides those skilled in the art with a convenient road map for implementing a preferred exemplary embodiment of the present invention. Accordingly, it should be understood that various changes may be made in the function and arrangement of elements described in the exemplary preferred embodiments without departing from the spirit and scope of the present invention as set forth in the appended claims.

1. A method comprising the steps of:
receiving a document request, said document request containing transaction data;
adding profile data to said transaction data;
extracting forms from a document library;
adding said forms to said profile data and said transaction data, thereby implementing a loan package that is responsive to said document request;
performing calculations to generate loan-specific data;
performing rule processing on said forms and said loan-specific data, thereby incorporating said loan-specific data into said forms; and
implementing a universal document package from said loan package.

2. The method of claim 1 further comprising the step of transmitting said universal document package to a first service provider.

3. The method of claim 2 wherein said first service provider inserts a document into said universal document package, thereby implementing an updated universal document package.

4. The method of claim 3 further comprising the step of applying a first digital signature to said updated universal document package.

5. The method of claim 3 wherein said first service provider is one of a lender, a mortgage broker, or a title company.

6. The method of claim 3 further comprising the step of transmitting said updated universal document package to a second service provider.

7. The method of claim 6 further comprising the step of said second service provider extracting said document from said updated universal document package.

8. The method of claim 7 further comprising the step of said second service provider auditing said document extracted from said updated universal document package.

9. The method of claim 6 wherein said second service provider is one of a lender, a mortgage broker, or a title company.

10. The method of claim 1 further comprising the steps of:
transmitting said universal document package to a first service provider, said first service provider inserting a document into said universal document package, thereby implementing an updated universal document package; and
transmitting said updated universal document package to a second service provider, said second service provider extracting said document from said updated universal document package and auditing said document.

11. The method of claim 10 further comprising the steps of:
approving said document;
applying a second digital signature to said document; and
reinserting said document into said updated universal document package.

12. The method of claim 1 wherein said step of implementing a universal document package from said loan package comprises the step of implementing said universal document package as an XML file.

13. The method of claim 3 wherein said step of implementing an updated universal document package comprises the step of processing an XSL file to update an XML file.

14. The method of claim 7 wherein said step of said second service provider extracting said document from said updated universal document package comprises the step of processing an XSL file to procure one of an XML file or an XHTML file.

15. The method of claim 11 wherein said step of reinserting said document into said updated universal document package comprises the step of processing an XSL file to update an XML file.

16. An apparatus comprising:
at least one processor;
a memory coupled to said at least one processor;
transaction data residing in said memory;
a profile database residing in said memory;
a document library residing in said memory; and
a document transaction mechanism residing in said memory and being executed by said at least one processor, said document transaction mechanism being configured to:
extract profile data from said profile database;
extract at least one form from said document library;
combine said profile data with said transaction data and said at least one form, thereby implementing a loan package; and
combine said loan package with a communication section, a history section and a toolbox section, thereby implementing a universal document package.

17. The apparatus of claim 16 further comprising a fax server residing in said memory.

18. The apparatus of claim 16 further comprising a web server residing in said memory.

19. The apparatus of claim 16 further comprising an e-mail server residing in said memory.

20. The apparatus of claim 16 further comprising:
a fax server residing in said memory;
a web server residing in said memory; and
e-mail server residing in said memory.

21. The apparatus of claim 16 further comprising a network coupled to said apparatus and being configured to communicate with said apparatus.

22. The apparatus of claim 21 further comprising an information requesting computer coupled to said network, said information requesting computer providing said transaction data and requesting said loan package.

23. The apparatus of claim 21 further comprising an information providing computer coupled to said network, said information providing computer providing information relative to said loan package and updating said universal document package.

24. The apparatus of claim 21 further comprising:
an information requesting computer coupled to said network; and
an information providing computer coupled to said network.

25. The apparatus of claim 16 further comprising:
a fax server residing in said memory;
a web server residing in said memory;
e-mail server residing in said memory;
a network coupled to said apparatus and being configured to communicate with said apparatus;
an information requesting computer coupled to said network, said information requesting computer providing said transaction data and requesting said loan package; and
an information providing computer coupled to said network, said information providing computer providing information relative to said loan package and updating said universal document package.

26. The apparatus of claim 23 wherein said information providing computer applies a digital signature to said universal document package after updating said universal document package.

27. The apparatus of claim 16 wherein said step universal document package comprises an XML file.

28. The apparatus of claim 16 further comprising a plurality of XSL files, said plurality of XSL files being configured to extract a document from said universal document package, insert a document into said universal document package, and update said universal document package.

29. A program product comprising:
a document transaction mechanism, said document transaction mechanism being configured to:
extract profile data from said profile database;
extract at least one form from said document library;
combine said profile data with said transaction data and said at least one form, thereby implementing a loan package; and
combine said loan package with a communication section, a history section and a tool section, thereby implementing a universal document package.

30. The program product of claim 29 wherein said signal bearing media comprises recordable media.

31. The program product of claim 29 wherein said signal bearing media comprises transmission media.

32. The program product of claim 29 wherein said document transaction mechanism is configured to implement said universal document package as an XML file.

33. A universal document package comprising:
a communication section;
at least one draw section;
a toolbox section; and
a history section.

34. The universal document package of claim 33 wherein said communication section is configured to communicate with a plurality of service providers and wherein said communication section comprises:
a plurality of communication protocols;
information regarding a plurality of posting locations; and
a plurality of web site locators.

35. The universal document package of claim 33 wherein said at least one draw section comprises:
at least one document order;
at least one loan package; and
at least one service response received from at least one service provider.

36. The universal document package of claim 33 wherein said toolbox section comprises a plurality of tools that are configured to allow a plurality of service providers to review, audit, and update said universal document package.

37. The universal document package of claim 33 wherein said history section comprises a transaction log for at least one service provider, said transaction log comprising a record of transactions performed by said at least one service provider on said universal document package.

38. The universal document package of claim 33 wherein said record of transactions comprises at least one of an insert document action, an update document action or an extract document action.

39. The universal document package of claim 36 wherein said plurality of tools comprises a plurality of XSL files.

40. The universal document package of claim 33 wherein said universal document package comprises an XML file.

41. The universal document package of claim 33 wherein:
said communication section is configured to communicate with a plurality of service providers and wherein said communication section comprises:
a plurality of communication protocols;
information regarding a plurality of posting locations; and
a plurality of web site locators;
said toolbox section comprises a plurality of tools that are configured to allow a plurality of service providers to review, audit, and update said universal document package; and
said history section comprises a transaction log for at least one service provider, said transaction log comprising a record of transactions performed by said at least one service provider on said universal document package.

42. The universal document package of claim 41 wherein said universal document package comprises an XML file.
